(19) United States
(12) Patent Application Publication
(10) Pub. No.: US 2010/0013613 A1
(43) Pub. Date: Jan. 21, 2010

(54) Haptic feedback projection system

(76) Inventor: Jonathan Samuel Weston, San Francisco, CA (US)

Correspondence Address: Jonathan Weston, 81 9th Street #403, San Francisco, CA, 94103, US

(21) Appl. No.: 12/217,791

(22) Filed: Jul. 8, 2008

(51) Int. Cl. G08B 6/00

(52) U.S. Cl. 340/407.2

(57) ABSTRACT

This Haptic Projection System (HPS) synchronizes single impulses and vibrations transmitted through the surface material of the touch sensitive display. Impulse generators spaced equally around the edges of the screen can, by adjusting their relative intensities and timing, focus the impulses or vibrations to an approximate point, or series of points out on the screen surface. By focusing convergent haptic vibration patterns on the appropriate location, a sense of tactility, solidity, shape and even resistance and texture can be imbued in on-screen objects and controls being manipulated anywhere on the display surface.

### CROSS REFERENCE TO RELATED APPLICATIONS:

This application claims the benefit of PPA Ser. No. 60/958,080 filed 2007 Jun. 30 by the present inventors, which is incorporated by reference.

### FEDERALLY SPONSORED RESEARCH

Not Applicable

### SEQUENCE LISTING OR PROGRAM

Not Applicable

### BACKGROUND-FIELD

This application relates to haptics, or force feedback, specifically to an improved force feedback system for touch sensitive displays.

### BACKGROUND-PRIOR ART

Previously various means and types of sensory feedback have been developed, and integrated into computer and other graphic displays so as to add a sense of solidity, and more importantly reliability/verifiability to the operation, action, and reaction of objects touched by finger or mouse. This might include window borders flashing, a bell sounding, or anything to add depth and reinforcing confirmation to on-screen touch or click events, as finger or mouse input are commonly referred to, which would otherwise be imperceptible without direct eye contact with the on-screen object or control being actuated. Actual haptic (physical vibration and resistance) feedback began filtering in to consumer electronics and other applications over two decades ago with the advent of console video game controllers, such as steering wheels and joysticks, which vibrated, jittered, and otherwise sought to emulate the real world feel of a vehicle or other device's operation. Thrustmaster™ joysticks, which were available for PC as well as various video game console platforms, and more recently what amounts to a force-feedback seat cushion called a “rumble pack”, which initially coincided with the Super Nintendo game console circa 1986 have both continued to release updated versions to this day. These, however, employ(ed) fairly crude impulse patterns of explosions, gunfire, and the off road vibration of virtual wheels. In what could be described as “representative feedback”, the same basic pattern or routine is repeated steadily for as long as the trigger condition remained true. Other than a sort of thematic background accent, feedback at this level can't actually contribute more to the users interface than “gun still shoots (bang, bang, bang), or right wheel still off side of track (thu . . . thu . . . thu . . . thu ). . . . that's better.” These are basically one dimensional warning lights with multi-media production values of varying degree.

Alternatively, some examples at the high end of haptic feedback applications are what could generally be described as remote surgery devices wherein a surgeons hand at one location, grasping a replica of a surgical tool handle, can actuate a robotic scalpel in actual surgery at another location. Through a sophisticated mechanical linkage, the surgeon's fingers feel the actual resistance experienced by the blade as it cuts through, or stitches up human flesh at the other end. Data from pressure and other sensors within the workings of the mechanical blade are interpreted and transmitted back through the remote handle in the surgeons grasp. This is unquestionably an impressive accomplishment and there are other examples almost as highly evolved, but as one would guess applications like this are almost exclusively custom in nature and beyond the means of any but a few corporate, institutional and government entities.

Whether video games or surgery, however, all of these examples of prior art haptic feedback involve transmitting said feedback through a physical controller created specifically for, and fixed to the individual purpose at hand. With respect to directly touch actuated displays, haptic feedback first became widespread in auto dashboard navigational screens. Here mostly uniform impulses confirmed actuation of an on-screen button without the driver needing to shift line of sight and attention between the road, and map screen menu. Since these PDA like tablets are for the most part an LCD screen encased in plastid, they have been amenable to adaptation of cell phone vibrator motors and similar impulse generating devices well known in the trade. That, and the relatively unchanging layout of simple menus in the navigation software led the industry to do the practical and expedient thing, which was/is to divide the screen up into several more or less permanent buttons, each with its own dedicated haptic and touch event processing resources. This has seen the most widespread use in Apple, Inc.'s popular iPod™ and iPhone™ devices, as well as similar competing products. Turning a digital touch sensitive dial on the iPod™, or touch-clicking one of the iPhone™'s on-screen icons is accompanied by a perceptible click or clicks. None of these prior art applications of haptic feedback are productively applicable to a standard (12″ or larger) sized display surface, where all the on-screen objects and controls are movable, scaleable, and without fixed points.

Most recently Immersion Corp., of San Jose, Calif. has patented and begun to market what is being called TouchSense™, a system whereby users, or at least developers, can to some extent assign patterns of clicks to a finite number of on-screen controls or events. These assignments are acted upon by a solenoid or other impulse generating device contacting a post which, with a small amount of freedom to move in one dimension against a counter spring, supports all or most of an entire flat screen, for example. Thus the impulses transmitted to this post lead to a uniform mechanical vibration or movement of the entire screen surface simultaneously. This is a lot of un-sprung weight, however sturdily controlled or guided, and still provides no means or opportunity for haptic representation of moving, or spatially oriented objects. It does not appear to possess the capacity for the necessary speed, accuracy, and responsiveness to generate recognizable textures from haptic vibrations, or the durability needed to sustain prolonged mechanical vibration of this type.

### SUMMARY

In accordance with one embodiment, a haptic feedback projection system focuses haptic feedback, also known as force-feedback, vibrations and impulses to any point on a two dimensional touch sensitive display. Virtual on-screen controls and objects, when enhanced with these projected impulses create a more tangible, solid, and informative total interface and can accompany these controls and touch actuated objects as their on-screen positions change.

### DRAWINGS-FIGURES

FIG. 1—is a perspective view of an exemplary embodiment of my haptic feedback projection system comprising a touch-screen, a PC tower, four impulse generators, a junction box, and associated power and signal cables.

FIG. 2a, 2b, and 2c —are perspective views of a variable frequency peizo/magnetic buzzer, a push/pull solenoid, and a vibrating/stepper motor respectively employed as the method or engine of impulse generation, shown here acting on the corner of a touch-screen as in 12 of FIG. 1.

FIG. 2d —is a series of facing, elevated front views of a hybrid vibration/stepper motor as the imbalanced flywheel rotates through one 360° step, and one contact with the screen surface.

FIG. 3a —is a perspective/cutaway view of an individual impulse generator housing with exposed mounting hardware.

FIG. 3b and 3c —are plan/elevation views of alternative impulse generator base-plate configurations.

FIG. 4 —is a facing view of two touch-screen display surfaces, each with an exemplary users hand superimposed over an on-screen, touch actuating control or object.

FIG. 5 —is a facing view of two touch-screen display surfaces, each with an exemplary users hand superimposed over an area of the screen virtually embodied with texture feedback—in this example sand.

FIG. 6a, 6b and 6c —are facing views of an enlarged portion of a touch-screen display 3 with the outline of an exemplary users two fingers superimposed over the surface, on which is represented the six dot matrix of the brail alphabet, and with a hypothetical brail letter indicated by some of those dots being black.

FIG. 7a and 7b —are facing views of a touch-screen display with impulse generators mounted on the corners, and two different levels of magnification of an on-screen virtual phonograph turntable.

FIG. 8 —is a facing view of a touch-screen display with impulse generators mounted on the corners, an on-screen virtual phonograph turntable, and a graphic representation/reassembly of the audio wave signal associated with actuating the virtual turntable extending below.

### DRAWINGS—REFERENCE NUMERALS

12 Touch-screen surface
14 Impulse generator assembly
16 Generator assembly clamp
18 Shielded cable
20 Quad impulse oscillator/amp.
22 PC tower
24 USB to PC (touch input)
26 PC to impulse amp cable
28 AC power
30 Touch-screen body
32 Impulse amp 110 v plug
34 110 v AC wall socket
36 SVGA/UVGA from PC
38 Piezo/magnetic buzzer
40 Footprint of 38 affixed
42 Wave entering surface
44 + and − signal leads
46 Push/pull solenoid
48 + and − power leads
50 Solenoid post
52 Plastic impact shield
54 Vibrator/Stepper motor
56 + and − power leads
58 Unbalanced flywheel
60 Teflon skid disc
62 Mounting posts
64 Generator mechanism cavity
66 Impulse generator housing
68 Impulse generator base plate
70 Reflection damping base plate gasket
72 Non-damping base plate feet
74 Impulse generator housing fasteners
76 Deep counter-sunk fastener holes
78 Virtual audio cross-fader control
80 Converging impulse waves
82 Touch/target deviation interval
84 User's hand
86 Two-touch hand position for knob
87 Gap in virtual doorknob finger position
88 Virtual doorknob
90 Finger furrow sides
92 Finger tip traces
94 User's hand (different sheet from 84)
96 Wind blown /ground effect sand
98 Ground effect sand grains
100 Top row dot pair
102 Right touch sense interval
104 Projected impulses
106 Left touch sense interval
108 Null impulse
110 Mid row dot pair
112 Low row dot pair
114 Users hand
116 Sequence time display
122 Virtual turntable
124 Virtual phonograph stylus
126 Virtual vibration path
128 Touch screen user's hand
130 Virtual record groove
132 Forward scratch stroke
134 Backward scratch stroke
136 Forward scratch wave
138 Backward scratch wave
140 Transition point

### SPECIFICATION

The embodiment described herein utilizes a touch sensitive display 30 employing surface waves as the medium of touch detection. The only requirement for the proper functioning of this technology is a flat, smooth, semi-hard surface on the exterior of the display 12. This is also the only required display surface parameter for the projection of haptic feedback, though screen surface material and it's resonance/reverb characteristics effect the strength and clarity of the projected haptic feedback. Any touch screen technology could be envisioned in alternative embodiments based on these considerations.

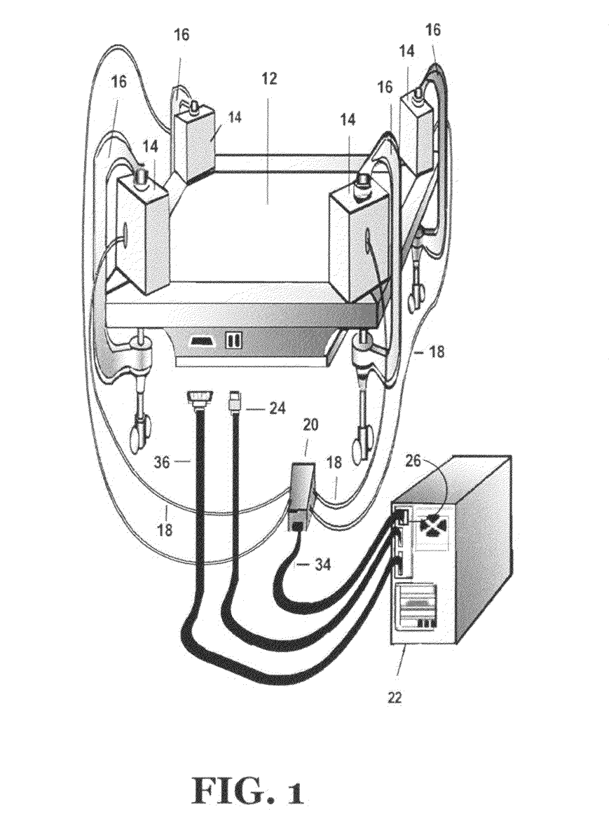

In FIG. 1, four impulse generators 14 are mounted onto the four corners of the display surface 12 by means of a clamping device such as the C clamps 16 depicted in this simplest-case embodiment. Power/control lines 18 run from these impulse generators 14 to a junction box 20, and this in turn is connected to a serial port 26 on the PC tower 22 by means of a shielded cable 34. Additionally, power for the impulse generators is obtained either from the PC tower 22 as built into USB or serial port connections, or through a separate cord 32 running to a 110/220v AC wall socket, and a step-down transformer on the plug or box end, as are both available from any electronics catalog. The resulting DC voltage can vary depending on the amperage needed to drive the impulse generators 14. The screen 30 is connected to the PC tower 22 by the expected D-sub SVGAIHVGA video cable 36, and additionally by a USB or serial cable 24 carrying the touch-event data traffic. The touch-screen 30 obtains power directly from a 110/220v AC wall socket.

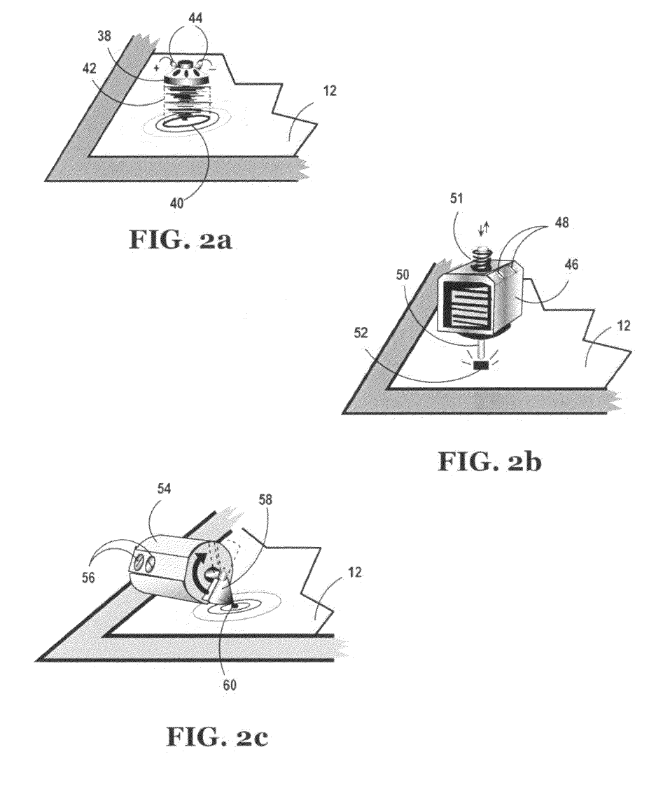

In FIG. 2a, 2b, and 2c, three impulse generation devices with differing performance characteristics are depicted acting on a representative corner portion 12 of a display surface as in 12 FIG. 1. These are a peizo-electric buzzer/speaker 38, a solenoid 46, and a vibrator-motor 54 respectively. Together, they cover a wide range of desirable performance characteristics and capabilities sufficient by one combination or another to operate as described in the following. These are by no means exclusive, however, and any number of widely known devices for converting electrical energy to mechanical could be employed separately, or within the same impulse generator housing to good effect. Simple crossover circuitry such as employed in a common, prior art loudspeaker can be trivially adapted to routing incoming impulse patterns between impulse generation means within the same housing or location.

### Solenoids

A solenoid 46 works best for projecting single or discrete impulse patterns with accuracy, and clarity. The main disadvantage of solenoids is the limited speed and variability of the push/pull cycle, which involves reversing polarity on 48 to pull the post 50 up for another downward push and impact with 52, or the max frequency attainable with a return spring 51 doing the upstroke pulling automatically. This limits their ability to project texture, and other non-discrete impulse patterns the nature of which will be described in detail following specification of the assembled and functioning device.

### Peizo-Electric Devices

A peizo electric buzzer 38 is the most versatile of impulse generating devices. Buzzers and noisemakers of this type can be adjusted with respect to frequency and amplitude via the line level signal running to it's positive and negative leads 44, it's only control requirements. These are the two most important parameters with respect to projecting texture and/or movement and resistance. They also require no protective layer at the point where impulses 42 are delivered to the screen surface inside footprint 40. This type of impulse generator's biggest disadvantage is in lacking a strong, defined single impulse projection capability.

### Vibrator-Motors

In FIG. 2c, a vibrating electric motor 54 has an imbalanced flywheel 58 mounted directly on the rotor which produces vibrations at a frequency equal to the r.p.m. As employed here for impulse generation, the flywheel is situated so as to make contact with a protective skid pad 60 on the screen surface (an alternative embodiment would substitute a nylon, or other non-abrasive shoe over the contact area of the flywheel. The advantage of vibration motors is their ability to produce higher frequency impulse patterns with less cumulative direct impact than a solenoid, while still delivering a distinct, physical impulse to the vibration conducting surface. The disadvantages are electromagnetic emissions, and the need for precise tuning at the contact surface.

An alternate hybrid embodiment of a vibrator motor 54 involves placing the same imbalanced flywheel on a stepper motor. A stepper motor is one which is designed to rotate, usually with high torque, a set predetermined number of degrees with each cycle for actuating various robotic and automated discrete motions like flipping a component on an assembly line, or closing a robotic pincher. In FIG. 2d an elevated facing view of such a motor 54 with imbalanced flywheel 58 is pictured in four different phases of one cycle producing a single impulse when said flywheel 58 contacts skid pad/ridge 60 on it's steeper side. The first phase results when the stepper motor actuates with a brief, high torque, high intensity twist of the rotor, throwing the weighted pie wedge of the flywheel 58 up to position 55, thereby storing some of the initial push in potential energy to be released if/when the weight returns to the lower position it started in. In the second phase this potential energy is released, and combined with any further torque being applied by the motor, swinging down to position 57 and contacting the near perpendicular lip 60 to create a significant impulse. In phase three the flywheel breaks past the lip, expending any residual energy in rising to hypothetical position 59, and then in the fallback of phase four returns to halt on the much lower angle of attack impact 61 with the lip 60 from the reverse side.

### Impulse Generator Housing

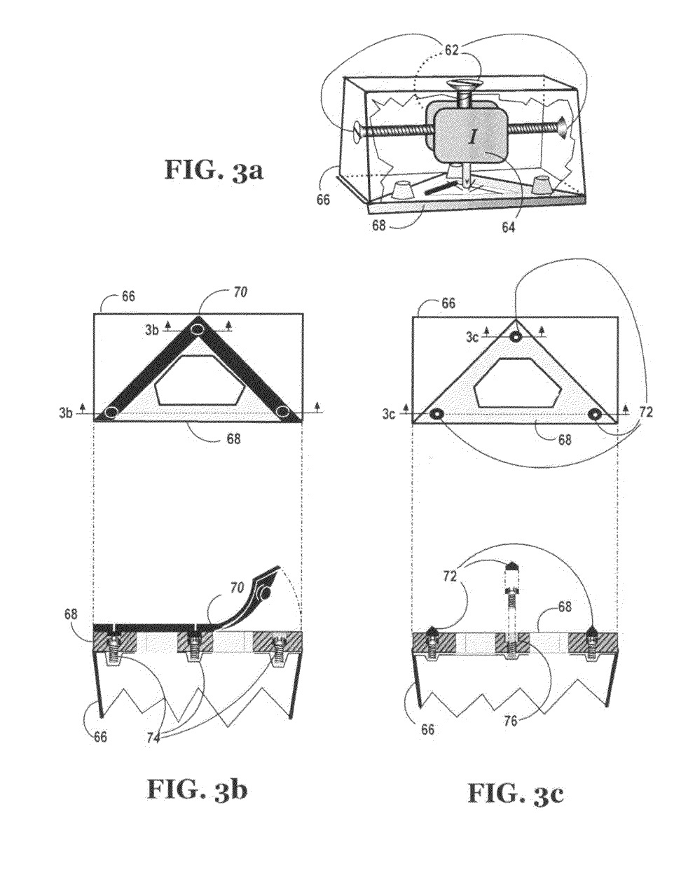

For simplicities sake the impulse generator housing 66 of FIG. 3 displays the built in hardware for mounting one impulse device/engine inside 62. It is plain that, by trivial extension, this hardware could be modified or expanded to accommodate mounting two or more devices of sufficiently small size in the same housing, depending on the application and requirements. The triangular opening in the housing base 64 is naturally suited to hold three without further modification.

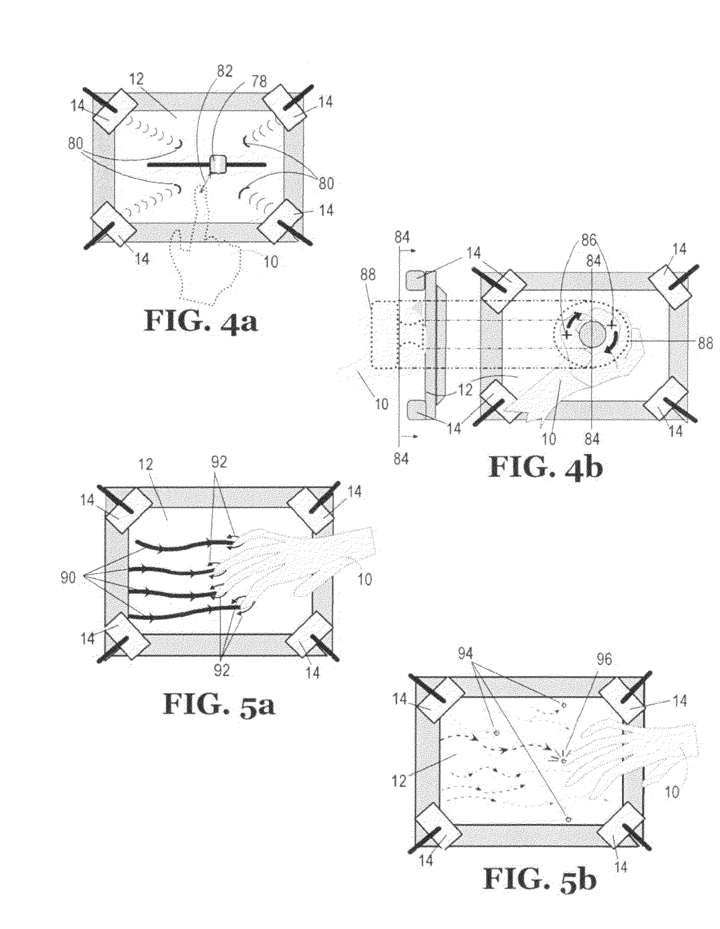

In FIG. 3 an impulse generating device such as 38, 46, or 54 in FIG. 2 is mounted within a metal, electromagnetically shielding housing 66 affixed to a base-plate 68 shaped to fit into the corner of a touch-screen display surface 12 while covering the smallest possible area from sight and touch. This is done so as to position the contact point/edge 40, 50, or 58 of the device slightly above the screen surface 12 when the assembly 14 is secured firmly onto it with a clamp 16. In various embodiments of my haptic feedback projection system and it's components this clamp may be separate as pictured, incorporated into a one piece housing/clamp, or if the exterior and rim of the touch-screen display is structurally solid enough, fixed directly to the rim of the screen by bolts or other fasteners. The housing 66 rests on a triangular base-plate 68 the lower surface of which rests on the screen 12 with one of two sets of rubber shoes. The first consists of one L shaped gasket 70 per base-plate with cylindrical protrusions on one flat side corresponding to the deeply countersunk fastener holes 76. The fasteners 74 screw in sufficiently past flush to accommodate the protrusions on the L shaped gasket 70, which are sufficiently larger in diameter than the holes to ensure a secure fit. The second consists of three rubber feet 72 per base-plate, which are cylindrical and of the same diameter as the protrusions in FIG. 4a on one end, and conical on the other. This footprint minimizes contact surface area, and as a result minimizes the damping caused by the vibration absorbent foot/gasket material. When the L shaped footprint 70 described previously is placed on and oriented to the screen corner as pictured in FIG. 1, the damping effect of the L shaped rubber/plastic contact area effectively prevents vibrations and impulses from traveling away from the center screen area and bouncing or reflecting back from the outer corners/sides of the screen. This can produce “echoes” and general muddying of the impulse patterns under certain circumstances. Likewise certain patterns or virtual “feels” are more susceptible to these types of distortion than others. Based on experience, and the particular application, a typical user should quickly discover the optimal contact shoe configuration out of the two through trial and error, and depending on their particular situation and preference.

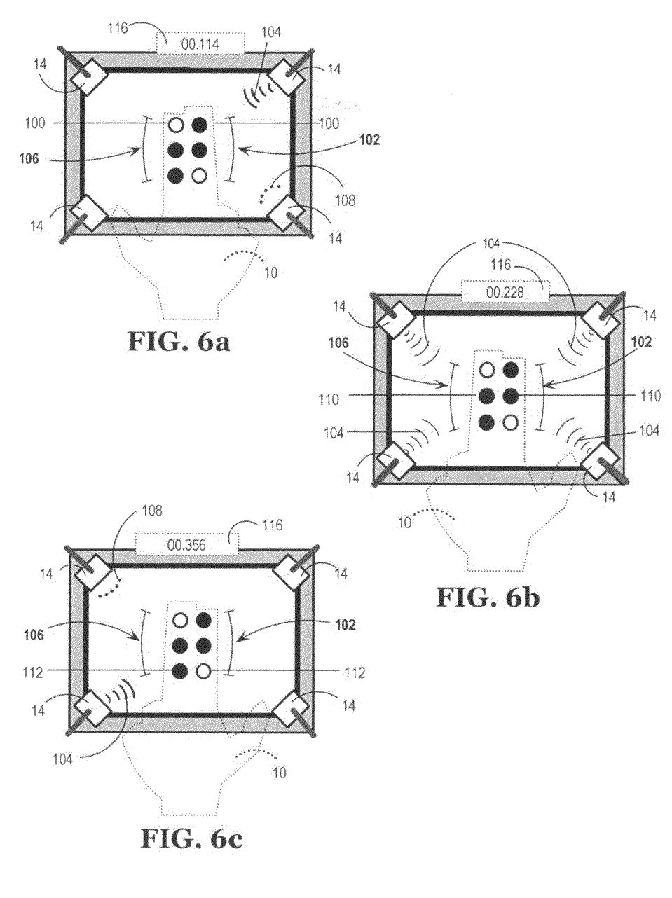

In FIG. 6 a facing view of a display surface 12, the mounted impulse generators 14 here presumed to be connected to and ready to function with the junction box 20 and PC tower 22 of FIG. 1 as the embodiment described previously. Additionally an on-screen slider control and its knob 78 are shown as if in use by an exemplary user, the outline of who's hand 82, and particularly the tip of the index finger is shown making contact below and to the left of the on-screen slider control knob 78 by an interval 80 recognized and available as a parameter accompanying the touch event or click event in Visual Basic or C+. With the touch-screen driver source code made available by ELO, and presumably other manufacturers, a proprietary range of screen coordinates which maps 1 for 1 directly into the windows API coordinates can be monitored, or spliced into and altered. This and similar junctions are what make possible effects such as a “close enough” range, wider than the actual control object pictured, but within which a touch event will actuate the control as if the event has registered within the boundary of the control. The HPS embodied here makes use of this coordinate translation process by routing a copy of the incoming touch data into a directX routine, in this case easily accessed through Visual Basic code incorporating an encapsulated directX access procedure, or wrapper. The directX components, directDRAW and directPLAY make it possible to accompany on screen events in video games with way files of sound effects, and rudimentary force feedback delivered through joysticks and other game controllers. It can be used similarly to store and trigger impulse patterns, requiring only quadraphonic or surround sound capability, which is presently commonplace both in games and systems using directX, to deliver four independent channels, or streams of impulse triggers. These can be electronically processed or amplified with simple, passive components as discussed previously into a form suitable to be fed directly into a particular impulse generation devices. The entire preceding paragraph merely details the application of DirectX and a variety of electromagnetic noisemakers more or less as they are commonly employed, with the possible need to insert at most an operational amplifier chip of size DIP-8 or comparable. That all of these components can function individually as described is left as obvious and/or trivial prior art, well known in the relevant trades.

This embodiment and it's components in FIG. 6 are engaged in something completely new, and non-obvious from the point where several, in this case four synchronous, very similar vibration patterns 79 are transmitted into the solid surface of the screen 12 by any of the previously described means 38, 46, 54 housed and mounted 14, and clamped 16 onto the corners of said display surface 12. Through arriving at this point many unmistakable similarities between certain portions of the preferred embodiment and a small scale quadraphonic or surround sound system have emerged. Transmitting vibrations of the sort produced by the real counterparts of on screen virtual objects and controls poses several unique limitations which differentiate the components of my haptic feedback projection system and the wave patterns it attempts to reproduce away from all but the most general similarities with existing audio playback equipment. These obstacles come about because:
i. The path from where any of the impulse generators 14 contact the screen surface 12 to where the users hand/finger does, at the lower end of interval 82 in FIG. 6a, is in most cases many times the distance vibrations must travel from their source to the users hand in the non-virtual, or actual thing of a typical on-screen object. The slider switch in FIG. 6a and the doorknob in FIG. 6b are two unambiguous examples of this common situation.
ii. The wide range of vibrations and impulses, each with its own wavelength, frequency, etc. will not travel through the screen material over the typically longer than actual distances without the various signals deteriorating asymmetrically to the point of being unrecognizable when compared with the original pattern or recording, however obtained.

For these reasons the initial process of developing believable or at least useful object or situation specific impulse patterns is one of trial and error. With the hand of a representative test subject on the screen, and one or more means of manually variable impulse generation, and a minimal amount of patience or intuition one can reverse engineer some kind of stylized haptic representation of any control or moveable object that can be visually represented on screen.

A typical embodiment of such a compound, object-specific feedback pattern or file might contain one higher, adjustable frequency, more or less perpetual vibration component for “texture”, and one or two patterns of relatively pronounced individual, asymmetrical, or discrete impulses roughly suggesting mechanical actuation sound effects, or their bounds. Said “components” might be embodied in dedicated impulse generating hardware specifically suited to a particular virtual replication, or comprise nothing more than a collection of files or patterns, with said files or patterns to be sent through the common impulse generating devices present in the generator assemblies as previously described.

A small, push/pull or spring loaded solenoid capable of rapid, continuous cycling as in FIG. 2b would be an exemplary device for actuating a representative high frequency texture component, as would a wide array of possible peizo-electric devices such as that in FIG. 2a. Discrete, low frequency, non-persistent components would be suitably embodied in dedicated or projected through certain common devices like a larger version of the solenoid in FIG. 2b made controllable at the individual impulse with a 360 degree step.

On screen controls are by definition visual, two dimensional representations of real and familiar three dimensional objects. As a consequence the users total contact interface with a real object, which could include the entire palm-side surface of the hand and fingers wrapped around an actual doorknob, for example, reduces down to a few square centimeters of two dimensional surface area in the virtual equivalent 88 shown in FIG. 6b. First among many obvious difficulties that accompany this loss of a dimension, and typically drastic reduction in user contact surface area is that there is nothing actual to push against, or offer variable physical resistance to the motion or actuation of on-screen virtual objects. Similarly, the two dimensional display surface provides no user interactive depth. When introduced to the market in 2005, the ELO Intelli-touch™ touch-screen system was unique in its touch pressure sensitivity, which does allow for a limited “z” or third dimension capability. With respect to an embodiment of incorporating this capability, pressure applied to an on screen object can be used as a proxy for intentional motion, so that in the example of the doorknob in FIG. 6b the length or intensity of pressure on the circular surface area of the pictured knob would be interpreted as pushing open the virtual door it is attached to. Given a user finger in contact with the board 82 reductions in detected pressure can likewise proxy for pulling a virtual object toward the user and out of the screen. Where this z dimension is unavailable, circumstantially un-useful, or otherwise employed several tricks and techniques can be used to incorporate touch-screen, haptic feedback capabilities to existing activeX and other developed-for-mouse controls.

In FIG. 6b the users hand 82 is shown “grasping” the virtual doorknob by making the shape of a hand grasping a doorknob as pictured, and pressing it into the on-screen doorknob. This is done so as to make contact first with the leading edge of the first knuckle on thumb and forefinger 86, both within the outer circumference of the virtual knob 88. This is the most anatomically intuitive and easily accomplished procedure for grabbing two separate touch contact points 86 whose relation, as the hand 82 rotates in the direction indicated while maintaining contact at both points, can serve as the basis for rotation of the virtual knob 88, and the associated haptic feedback. In the interest of maximizing the two dimensional surface area of contact between user and screen, the entire leading edge of thumb and forefinger can be pressed to the screen, providing the two points 86 come down distinctly and in advance of the rest, and that there remains a gap 84 of contiguous untouched surface area connecting the center point of the knob to it's outer boundary. With the hand positioned accordingly, patterns of impulses from the four generators 14 can be felt around the outside of the C shaped user contact area generally superimposed over the lower half circle or hemisphere of the virtual knob 88's exterior boundary. By leaving the tip of the thumb and forefinger slightly off the screen surface as they are anatomically inclined to do, the upper hemisphere remains a clear path for those impulses from the upper right and left generators. The impulses from these can be perceived most clearly around the inside edge of this C shaped contact area, and this haptic feedback simulates vibrations and friction as they are commonly felt originating from the central axle or post of a doorknob. The traversing of an attached bolt or latch can be easily felt in most cases when turning an actual doorknob. This perception of friction, and the linear motion of the bolt causing it, seems by general consensus to originate from a fixed point midway between the knob, and the nearer edge of the door as the users hand rotates past it clasping the knob. Adding this mechanically generated component of the feel of an actual doorknob to the friction of the knob turning as described above creates a compound touch feedback impulse scheme. By projecting a clean, distinct, uniformly repeating impulse pattern at a point a few inches to the right or left of the onscreen knob's location, a sensation similar to manually rotating a spark plug or other socket on a common ratchet handle is created. By slowly increasing the frequency of this impulse pattern, and either through adjusting the impulse generators to fall a fraction of a second out of phase with each other, or de-regularizing/“humanizing” the individual impulse pattern of a single generator by other means a muddier, smoother, more continuous vibration results. Minor trial and error adjustment of the available parameters at this point will eventually arrive at a “feel” recognizable by most users as similar to the feel of an actual bolt being traversed open or closed.

### SURFACE TEXTURE SIMULATIONS

In FIG. 5 a patch of virtual surface is indicated by the lighter colored rectangle on the touch-screen surface pictured in parts a, and b. A prospective users hand and fingers 94 are superimposed over this patch, and are understood to represent said hand and fingers midway in the process of dragging the four fingertips pictured across and in contact with the patch and screen 12 from the left side to the right side. The desired texture simulation indicated by the arrows in FIG. 5a, and 5b is of “sand at the beach” with the feel of the fingertips furrowing through the surface of dry sand as it flows around 90 and under them 92, there is almost always the continuous tingle or sting of individual airborne grains of sand 96 carried along just above the surface by the ground effect of any wind as they impact the fingers 98. A smooth, low frequency vibration coming equally from the upper and lower impulse generators 14 on either right or left side, but not both, synchronized to occur as the fingertip touch contact points 94 move, and with the frequency of the vibration positively correlated with the speed of movement by a small fraction, a rough approximation of the feel of sand traveling beneath the fingertips 92 can be effected.

By synchronizing a higher frequency, sharper vibration or wave from the other two impulse generators, using a particular wave exhibiting the “rolling” characteristic of continually looping in and out of phase with itself, at the back of the fingertips 94, a sensation with distinct similarities to the sand flowing around the sides of ones fingers in the actual experience being simulated. By tying or relating the phase of the two impulse generators on that side at the DirectSound or equivalent level, or in some instances fixing the vibration, and leaving the different and varying distances of travel for each vibration source to create a competing, “two sided” aspect to the mid frequency vibration pattern reaching the fingertips 94 and recreating a surprising likeness to sand between the fingertips.

Finally, very sharp individual, or high frequency impulses such as might be delivered by a very small solenoid or high performance tweeter, can be generated by feeding said devices an amplified sample recording of the crackle on an old vinyl record, or other grainy white noise, and create a reasonable simulation of the sting of ground effect sand from right, left, top or bottom mixed with the previous patterns.

Other examples in various states of refinement include wood (lumber, bark, finished), oil (⅛^{th} to ¼ inch on surface), ice, fur, and rusty chains—all of which can be recognizably simulated to some degree.

### ON-SCREEN BRAIL PROJECTION

FIG. 6a, 6b, and 6c are facing views of a prospective users hand 114 superimposed over a touch-screen surface. Said hand is presumed in each case to be pressed against the screen along the length of the two extended fingers, and the rest of the hands contact or lack of it made irrelevant either through hand position or contrived dismissal of extraneous touch input, which is trivially accomplished by existing, non-proprietary means. This two fingered position is presented as the preferred position, given the previously described embodiment of my haptic feedback projection system, for the successful projection of virtual brail to the hand/fingers 114 of a prospective user in this simplest case scenario. With that point made, any advantages it holds are marginal in comparison with numerous variations that provide at least an inch of roughly straight contact frontier with the screen similar to the interval 102 indicated in FIG. 6a, facing both right and left sides of the screen. Interval 102 and 106 together meet this rule of thumb as pictured, but so would one outstretched finger, or the back of a hand, and a number of possibilities limited only by the sensory discrimination of a particular patch of skin in the context of that individual. This may be of importance since the preferred position was not chosen on the basis of comfort, and extended use may be expected to give rise to problems and solutions with respect to hand position.

Up to this point only one on-screen control, or object at a time has been the intended recipient, or addressee of the haptic impulse output of my projection system. The impulse patterns, their overlapping components, vibration simulated textures et al have for the most part achieved some basic but undeniable level of performance through simply projecting them all in synchrony, with their intensity scaled to their perceived prominence and distance from the screen location being contacted by the user at that moment. The desired result with respect to brail requires that, with the user perpetually maintaining a given contact area with the screen, haptic impulses will produce the “feel” of two dots horizontally in line such as those on lines 110 or 112, with a detectible gap or proxy touch sensation dividing the two. This has to be distinct enough that two dots feel distinguishable from one big left or right dot, and vice versa, while projecting brail symbols rapidly enough to be useful.

Locating the dots of the brail pattern in their relative positions by the methods previously described would require figuring out the equivalent of their location in a stereo/quadraphonic field mapped onto the screen. Then by adjusting impulse generator intensities to center over the respective dots, and scanning through, or shifting this center from dot to dot at a high enough frequency in a manner similar to that which produces a TV picture from inside a CRT, theory would suggest that any of the six dots in the brail letter pattern could be made to seemingly rise up from the screen, maintaining their detectable presence with or without a user confirming this by touch. It is assumed that with little refinement and specialized materials already in existence, but economically out of easy reach at present, this will be the method employed in successive, functionally identical embodiments of my haptic feedback projection system. For the present, modifications and simplifications will now be outlined that will make the on screen projection of brail letters by embodiments such as that just described in this application, an efficient and effective interface for the sight impaired even when assembled from the most economical components available.

The hand position depicted in each successive step of FIG. 6, exposing interval 102 and 106 respectively to the upper and lower impulse generators 14 facing them, while blocking or damping impulses from the other side, creates the foundation of a reliable two channel touch interface between fingers and screen. Any number of very simple, repeatable representations of the three dot patterns comprising the right and left column of the brail letter centered on the screen in FIG. 6a could be contrived using single impulses from the upper and lower impulse generator 14 on the respective right or left side. A typical user's hand/fingers could be expected to acquire the ability to detect and differentiate reliably between these three possibilities with little time and effort. Doing this on both sides of the screen contact area at once presents little more difficulty, and makes possible the sequential communication of brail letters.

In this example each brail letter is communicated one two dot, horizontal row at a time, starting with the top row as indicated by the dotted line 100 in FIG. 6a. The presence of the right or left dot of the upper row in the particular letter being projected is indicated by a single or short interval of repeated impulses from the upper impulse generators alone, and sensed as right, left, or both. For the specific letter pictured in FIG. 6a, the right dot in the top row 100 of the six dot pattern is represented as being present with impulses similar to those represented in this example as a progression of white arcs extending from the upper right impulse generator 14 to where they will be felt roughly along the interval 102, unaccompanied by any perceived vibrations from the other side, and correspond to the right dot, no left dot permutation of the top row as pictured. In actual practice impulses, individual or in patterns or sequences, originating solely from the upper of the two impulse generators 14 on the right side of FIG. 6a are easily distinguishable from the same impulses if projected solely out of the lower right impulse generator 14, or from any pattern combining impulses from upper and lower right generators in a given short interval of time such as that shown successively by clock display 116 in FIGS. 6a, 6b, and 6c. Additionally upper, lower, or combination impulse patterns coming from either of the impulse generator pairs facing either interval 102 or 106 respectively are not inclined to be confused with identical patterns originating simultaneously from the opposite side.

FIG 6b corresponds to the same screen and users hand interface as in FIG. 6a after an interval of 0.114 seconds has elapsed as indicated by this amount incrementing the clock display 116 at the bottom of each part of FIG. 6. This is the lag between the projection of each of the three descending rows of two in the brail letter matrix. To indicate the presence or absence of a dot occupying the right or left side of this middle row in any particular brail letter, simultaneous impulses from the upper and lower impulse generator on each side are projected, and sensed along interval 102, and/or 106 as part of a right dot, left dot, or two dot row. In the specific case pictured in FIG. 6b there are two dots, which are projected as indicated by the sequence of expanding white curve segments 104 converging from upper and lower impulse generators 14 on intervals 102 and 106 respectively.

FIG. 6c, occurring an additional 0.114 second interval after FIG. 6b as shown in the clock display 116, depicts projection of the final two dot row of the example brail letter pictured in 6a and 6b, here indicated by dotted line 110, and comprising a left dot, no right dot pair as pictured. The bottom row of dots is indicated as filled or empty by an impulse or impulse pattern projected from only the lower impulse generators 14 on each side, here shown as the sequence of expanding white arc segments extending from the bottom left impulse generator to interval 102, along the left border of the skin contact area in accordance with the preferred hand position 114. As with the top 100 and middle 110 rows of the brail matrix, the bottom row brail dots 112, and the impulse patterns which indicate their presence are easily differentiable from all other impulse patterns used in this application. Cycling through the rows of a sequence of brail letters, top to bottom, in the manner just described, brail text can be projected and comprehended at a fairly rapid rate from almost anywhere on the screen other than the extreme edges.

In FIG. 6a, and 6c a null impulse 108 is pictured coming from the idle impulse generator 14 simultaneous to the substantive projection coming from the opposite impulse generator and signifying a dot on the other side of the pair in the brail letter being projected. The projection of a null or nominal impulse weak enough not to be confused with the substantive alternative has been demonstrated to smooth and or clarify an ongoing brail projection stream of the type described in some instances.

Though not evident at any speeds reachable in explorations to date, the top down stagger to projection of the rows of dots 100, 110, 112 could be expected at some point to produce an unavoidable sensation of the successive letters “rolling” down the users fingers, hand etc. The strength of this spatial inference varying as it would, from user to user, may cause the brail letters to be perceived as arriving upside down, bottom first, as a reverse image impression peeling off the original like tape and so on. To the extent examined, all of these “touch dyslexic” misperceptions represent distinct, discrete “folds” or reversals from expected sensory input, and can be corrected or unfolded by reversing the direction or sequence of dot rows. In the case of FIG. 6 switching from the order 100, 110, 112 to 112, 110, 100 would be an example. It should be clear that all such embodiments of my haptic feedback projection system as brail projector can be achieved by trivial modification of what has been described here.

To summarize a general characteristic upon which the brail projection system, and to some extent all of the examples in this specification depend for any of this to work, consider again the interval 102 in any of the parts of FIG. 6, and the three dot spaces pictured along the finger just behind the interval. For each row shown in turn as being projected from the corners of the screen, the impulse pattern of white arcs, though implying an expanding series of concentric circles, is actually portrayed much like a beam aimed directly at the particular row of dots. In actual practice, there is no real directionality to the impulses projected from each generator. Because the fingers remain stationary however, and the underlying impulses have been simplified and enhanced, simply expecting to feel a right, middle, and bottom will quickly have the nerves along interval 102 perceiving the three different impulses as each of the dots respectively, even though there is nothing like a stereo field focal point, or any notion of two generators of these projected impulse patterns intersecting each other over one or more of the respective three dots. The representations of the dots are not even symmetrical, yet despite these seemingly serious inconsistencies, the sensory input and the user's perception of it converge to the six dot patterns it “finds”, and this effect is even more pronounced with no visual feedback from the screen or elsewhere constraining this mental picture. Touch sensations in general are “user configurable” to a far greater extent than sight and sound. One has no solid expectation of how a tool or object should feel in ones grasp, and if one stops to think about it, the first few moments of having some new object in ones grasp is almost invariably spent contemplating “how does this feel” in step with determining how and when the associated sensations combine with the movement and action of a potential tool or projectile. This ability to analyze and adapt to new tools and objects through touch is easily co-opted to the task of making more believable imitations, and making imitations more believable through haptic feedback.

### VIRTUAL TURNTABLE

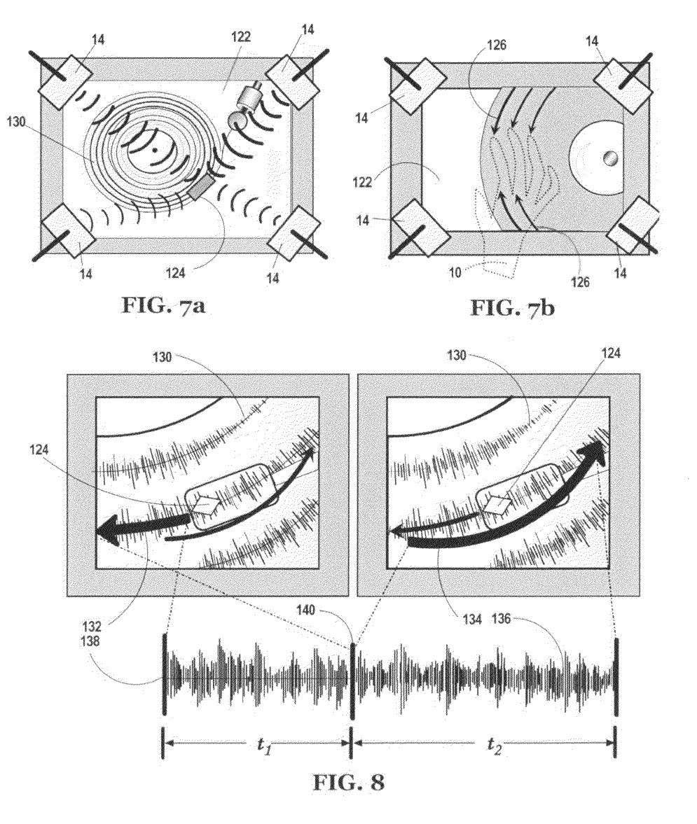

In FIG. 7a a touch-screen surface with HPS generators 14 mounted in the corners is pictured with an on screen image of a turntable 122 presumed to be an on-screen virtual audio control functioning in accordance with the operation of a standard actual DJ turntable such as a Technics 1200. Said virtual turntable 122 having a linear, spiral representation of the digital recording represented by virtual vinyl record grooves 130 on a black disk as displayed, with the virtual stylus 124 following said spiral representation from the outer circumference of the black disk to the outer circumference of the white disk or virtual record label over the course of playback of the recording, and in so doing following the proportional, and time-elapsed equivalent visually of an actual turntable stylus playing an actual 12″ record from beginning to end. This is all existing art software, or trivially modified from existing art with rudimentary Visual Basic or similar accessible code by following the conceptual recipe just specified.

Where existing art digital recording (CD, MP3) scratch simulators fall short is in using a scratch noise sample pitched to speed instead of manipulating the actual recording being played back, much less attempting to reproduce how this would feel/sound as a vinyl recording rather than a digital recording, which is distinctly different. With an actual turntable the scratching noise produced by accelerating, decelerating, and/or reversing the direction of rotation of the record, aided by a non-friction “slip mat” or “scratch-pad”, is not scratching as commonly understood, i.e. the stylus moving perpendicularly against the record grooves, but the sound of the music recorded in the groove being sped up and slowed down (a turntable does not require power to produce it's signal). As one natural consequence, the tone, pitch, and tempo all synch perfectly and smoothly up from and back to the 33 or 45 rpm levels as the record returns to the platter speed, and maintain some tone and sound qualities particular to a given track no matter how abrupt and extreme the departures from it in the form of scratching may seem. As important as all of this, the same kick drum, bass, and other recognizable features of a modern recording can be heard and felt through the record material, sped up or slowed down or backwards, and with the volume up or not. This makes it possible for the DJ to feel the vibrations of the record reversing back over a 4 beat measure, or 8 beat bar, and fade the turntable back into amplification in tempo and synched without headphones.

All of these capabilities and nuances can find some reproducible virtual form with the HPS equipped touch-screen in FIG. 7 and 8. To do so, the Impulse generators need only be sent the audio signal at an appropriately smooth amplification 126, and adjust their respective intensities to focus roughly on the region of the virtual record where the virtual tone arm and stylus rest over the record 124, an area avoided in the actual case for obvious reasons. With the vibrations thus focused, and received at the fingertips of 128 in FIG. 7b through a similar material to vinyl, from a distance near proportional to an actual record, one obtains an accurate representation of the feel of traversing an actual vinyl record back and forth. One can then link this haptic feedback first to initial touch input, which would trigger it, and then so as to match the speed of the playback to the speed of the groove passing the virtual stylus implied by the motion of fingertips along the virtual record. Multiplying the sampling rate/frequency of the wave file by a variable equated to rpm/33 or 45 of the hand 128 motions along 126, which will effectively vary the speed and pitch of playback Allowing for this speed to be negative to indicate reverse playback makes possible the sequence of events in FIG. 8 in which the virtual stylus 124 of FIG. 7a is presumed to have the virtual record groove 130 rotated under it by touch-slide-stop-slide contact finger motions as traced by darker arrow 132 from the middle dashed line to the leftmost, followed by lighter arrow 134 along the radial arc of the virtual record groove 130 back to the rightmost dashed line.

In the lower panel of FIG. 8 a more familiar wave editor representation of the audio content of the virtual record grooves, with the initial right to left rotations corresponding wave segment 136 graphically rotated around to display left to right directly prior to the left to right rotation 134 also shown in wave representation in the lower panel. Together these wave segments represent what would be heard chronologically in playback with 140 representing the transition point. The high speed of scratching back and forth would appear in wave representation as a speed proportional horizontal compression of the wave segments pictured.

Thus several advantages of one or more aspects and embodiments described above become evident, to provide haptic feedback in a wider variety of patterns and intensities than is possible with the prior art. Other advantages of one or more aspects are to make possible projection of haptic feedback anywhere on a display surface.

Metallic, dampened, and other mechanical “clicks” and “snaps” can be distinguishably felt when projected onto virtual representations of toggle, push-button, and discrete position rotary controls.

Simple, intuitively stylized representations of actuation and motion resistance can be achieved.

Brail letters can be recognizably projected to the screen. In the simplest embodiment individual impulses need only be recognizable as originating from right, left, upper, lower, or upper-and-lower middle to a finger tip or palm contacting the screen. With this simple capability alone brail words can be transmitted symbol by symbol through the screen surface.

Projection of simple, easily recognizable surface textures such as wood, oil, and sand can be made to accompany dragging or sliding fingertips across the screen.

A virtual turntable can be “scratched”, or rotated back and forth at high speed with the needle down as is common in popular music, with an accurate replication of the vibrations made by a particular vinyl record track at the pitch and tempo correspondent to a given needle-to-record speed.

Existing devices designed to simulate this scratching during the playback of digital recordings are extensive and well known in the market, but rarely deliver more than prerecorded or simulated scratch sound effects for the noise. Apart from the somewhat “canned” sounding output, the vibrations from the actual vinyl record groove are recognized and utilized by vinyl DJs to considerable effect, accomplishing that which cannot be replicated by existing digital simulations.

This and other advantages of one or more aspects will become apparent from the ensuing description and accompanying drawings.

Although the above descriptions are specific, they should not be considered limitations on the invention, but only as examples of the embodiments and applications shown. Many other ramifications, variations, and applications are possible within the teachings of the invention. For example, the previously described embodiment and applications all involved impulses being transmitted to the display surface from four points corresponding to the four corners of the screen and also to easily co-opted, pre-existing architecture in PCs and elsewhere for audio and surround sound. This, however, is incidental to the prototype and previously described embodiment. There is no conceptual limitation on the number of impulse generators, their nature, size, or placement except that a significant portion of the objects and advantages of my haptic feedback projection system derive from the possibility of transmitting these impulses and vibrations from location(s) far enough removed to be out of the way of the user on one face, and the display and its functions on the other. The overall scale of the haptic feedback projection system can be altered to the limits which available material and technology allow. In conjunction with this or independently the visual display can be projected onto any surface which can conduct vibration and simultaneously detect contact by any number of more straightforward existing means, thus allowing for a dance floor, or play-room floor scale embodiment without the need for an LCD or other internally generated display surface durable enough to be jumped on. Therefore, the scope of the invention should not be determined by the examples given, but only by the appended claims and their legal equivalent.

I claim:

1. A haptic feedback projection system for transmitting impulses and vibration patterns onto a touch sensitive display surface comprising:
a a plurality of impulse generators for propagating patterns of vibration at a plurality of points on the periphery of said display surface
b a control means for synchronizing and triggering impulse and vibration patterns from said impulse generators on the basis of user interaction with said display
c a means of storing and allocating said impulse and vibration patterns to onscreen events
Whereby said control means, upon detecting user interaction with said display surface, triggers said impulse generators with said allocated and stored patterns such that the cumulative effect detected by a user in contact with said display surface enhances the tangibility and facility of use of on-screen objects and controls to which said impulse and vibration patterns are allocated.

2. The haptic feedback projection system of claim 1 wherein on-screen objects and controls are enhanced by vibration and impulse patterns emulating the physical sensation of performing the same action on the tangible or material equivalent of said on-screen objects and controls.

3. The haptic feedback projection system of claim 1 wherein on-screen objects and controls, specifically their surface representations, are enhanced by vibration and impulse patterns emulating a physical surface texture of any composition of matter and allocated to user contact traversing the region of display surface corresponding to said objects and controls, objects being broadly interpreted to include windows, desktops, and other non-representative display backgrounds.

4. The haptic feedback projection system of claim 1 wherein vibration and impulse patterns provide a separate, sightlessly interpretable representation of possible touch interactions represented visually on said display surface.

5. The haptic feedback projection system of claim 1 wherein said touch sensitive display surface is a screen onto which the graphic display is projected externally.

6. The haptic feedback projection system of claim 5 wherein said external projection is onto a touch sensitive floor or wall, and the impulse generators mounted on the periphery are of sufficient scale to project haptic impulses detectable by users hands, feet, or any other anatomical part in contact with said display surface.
